(19) United States
(12) Patent Application Publication
(10) Pub. No.: US 2006/0132930 A1
(43) Pub. Date: Jun. 22, 2006

(54) Lens for a laser-ignited internal combustion engine

(76) Inventors: Herbert Kopecek, Halbergmoos (DE); Martin Weinrotter, Vocklabruck (AT); Christian Francesconi, Kapfenberg (AT); Ernst Winter, Oberwelden (AT); Johann Klausner, St. Jakob Im Haus (AT)

Correspondence Address: LORUSSO & ASSOCIATES, 3 PINECREST TERRACE, PEASE INTERNATIONAL TRADEPORT, PORTSMOUTH, NH, 03801, US

(21) Appl. No.: 11/311,932

(22) Filed: Dec. 19, 2005

(30) Foreign Application Priority Data
Dec. 20, 2004 (AT) A 2122/2004

(51) Int. Cl. G02B 3/02

(52) U.S. Cl. 359/718

(57) ABSTRACT

Lens for a laser-ignited internal combustion engine, with an at least approximately spherical basic shape, the lens (1) having an aspherical region (3) which is formed so that the lens (1) is at least approximately free from spherical aberration.

The present invention relates to a lens for a laser-ignited internal combustion engine with an at least approximately spherical basic shape.

Such a lens is disclosed for example in U.S. Pat. No. 6,053,140. The relatively poor image quality is a problem with this lens.

An object of the invention is to create a simple focusing lens system for the laser radiation used for the ignition, which does not have the problems of the prior art.

This is achieved according to the invention by the lens having an aspherical region which is formed in such a way that the lens is at least approximately free from spherical aberration.

The approximately spherical overall shape of the lens guarantees maximum mechanical resistance to the severe conditions prevailing in an internal combustion engine caused by combustion, cylinder pressure and mechanical loading. At the same time the aspherical region of the lens ensures the best possible imaging properties of the lens system and thus as small a focal point as possible, which in turn reduces the minimum laser power required for a reliable ignition of the fuel/air mixture and increases the efficiency of the entire ignition system. When the lens according to the invention is used no other optical elements per se are required in the area of the focusing lens system. However, collimation and expansion lenses for example can be provided, In order to change the beam to the diameter to which the spherical window has been sized.

In a preferred embodiment of the invention it is provided that the aspherical region is formed rotationally symmetrically in relation to an imaginary axis running through the center point of the spherical basic shape. This makes possible a particularly simple production and at the same time guarantees good imaging properties of the lens. With such a lens it is preferably provided that the aspherical region extends in relation to the imaginary axis from the polar angle θ=0° to at least approximately θ=45°. If even larger beam diameters can be used, it can preferably be provided that the aspherical region extends to approximately θ=90°.

Very generally, it can particularly preferably be provided with the lens according to the invention that at least in one portion of the aspherical region, for each point on the surface of the portion, the distance to the center of the spherical basic shape is different from the radius of the spherical basic shape. It can further be provided that the portion in which the distance of a point on the surface differs from the radius of the spherical basic shape is formed rotationally symmetrically in relation to an imaginary axis running through the center of the spherical basic shape.

In a further preferred embodiment of the invention it can be provided to develop at least approximately planar, concave or convex the area arranged opposite the aspherical region on the spherical basic shape in relation to the center (antipode). Through this measure any image defects can additionally be reduced.

A particularly simple version of the lens according to the invention results when it is provided that the aspherical region is formed as a simple continuation of the surface of the lens. In contrast to a perfectly well conceivable form of the aspherical region in the form of two or more aspherical portions distanced from each other on the surface of the lens, a simple continuation aspherical region is characterized by easier production.

As materials for the lens according to the invention, glasses for example, but also polycrystalline materials, can be used. For example, high-purity quartz glass, crystalline quartz, calcium fluoride, borosilicate glass, silica glass or sapphire can preferably be used.

The present invention also relates to a method for the production of a lens according to the invention.

Such a lens can for example be produced by working, preferably grinding, the aspherical region into an approximately spherical unfinished lens.

It is also conceivable that the raw material is pressed in a mould which is complementary to the intended shape of the lens. This allows the production of a lens according to the invention in a single step.

A further aspect of the invention relates to a housing for a lens according to the invention which is characterized in that it has seating surfaces which are formed for the play-free housing of the lenses and in that it is formed for fitting in a preferably cylindrical bore in the cylinder head of an internal combustion engine.

The housing is preferably made from a metal suitable for use in an internal combustion engine.

It is particularly advantageous if it is provided that the housing according to the invention comprises a hollow cylinder and a sleeve releasably attached, preferably fitted into, the hollow cylinder, the lens being able to be arranged between the hollow cylinder and the fitted sleeve. This allows a simple attachment of the lens. It is particularly advantageous to further provide that the hollow cylinder has at one end seating surfaces, which are formed complementary to a section of the aspherical region of the lens, and the sleeve has seating surfaces which are formed complementary to a section of the spherical basic shape of the lens. In this case the lens can be attached in the adapter by pressing.

The invention also relates to a cylinder head with a housing of the type mentioned above, a lens according to the invention being arranged in the housing.

Particularly preferably it is provided that the lens is simultaneously used as a combustion-chamber window. This makes it possible for the laser radiation guided in front of, at, or in the vicinity of, the respective cylinder head of the internal combustion engine to be introduced using only a single lens according to the invention focused into the combustion chamber of the internal combustion engine.

It is particularly advantageous if the combustion chamber-side surface of the lens projects if at all possible into the combustion chamber or at least ends flat to some extent with the underside of the cylinder head and the under side of the adapter, in order to obtain surface temperatures at the lens which are as high as possible and thus avoid deposits on the window. The spherical basic shape of the lens favors such preferred combustion chamber conditions while at the same time avoiding graduations or bases which, as tests by the applicant have shown, can lead to notch stress fractures.

Further advantages and details of the invention can be seen with reference to the following figures and to the associated description of the figures.

### These show:

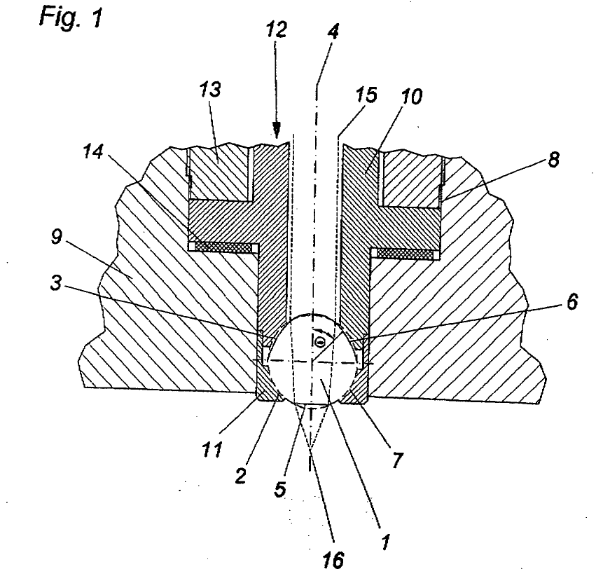

FIG. 1 a section through a cylinder head with a housing according to the invention and a lens according to the invention,

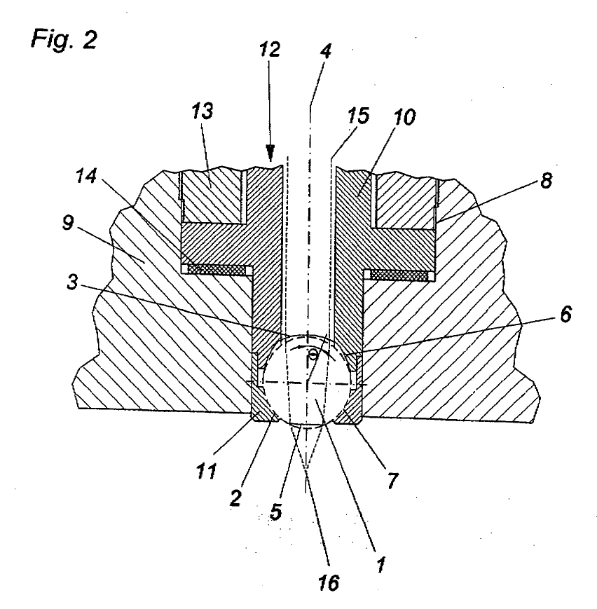

FIG. 2 another section through a cylinder head, wherein a further embodiment of the lens according to the invention can be seen and

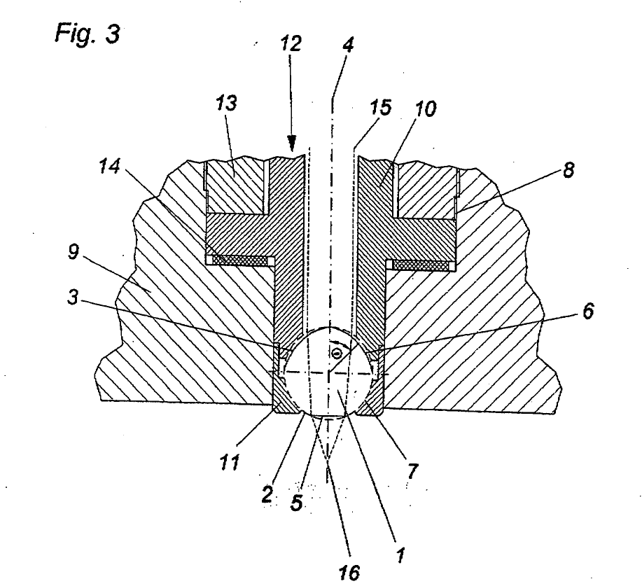

FIG. 3 another section through a cylinder head, wherein a further embodiment of the lens according to the invention can be seen.

FIG. 1 shows in a schematic sectional representation the underside of a cylinder head 9 which has an approximately cylindrical bore 8. A housing 12 according to the invention is inserted into the bore 8 and secured or sealed by means of a suitable fixing means 13 and a gasket 14.

It can also be seen that in this embodiment the housing 12 is designed in two parts, the first part consisting of a hollow cylinder 10 and the second part of a sleeve 11 (compression sleeve). The sleeve 11 is fitted onto one end of the hollow cylinder 10 and thus presses the lens 1 according to the invention, arranged between the hollow cylinder 10 and the sleeve 11, acting as a combustion-chamber window, between the sealing surfaces 6 on the hollow cylinder 10 and the sealing surfaces 7 on the sleeve 11. The sealing surfaces 6, 7 are formed complementary to the respective section of the lens 1. In this embodiment the seating surfaces 6 are therefore formed complementary to the aspherical region 3 of the lens 1, while the seating surfaces 7 are formed complementary to the spherical basic shape 2 of the lens 1. The lens 1 according to the invention is designed rotationally symmetrically in relation to the axis 4, the aspherical region 3 which is formed to avoid spherical aberration extending to approximately the equatorial plane of the lens 1. As is generally known to a person skilled in the art, spherical aberration affects in particular rays far from the axis, so that the deviation from the spherical basic shape 2 becomes more pronounced as the polar angle θ increases. The area 5 of the lens 1 arranged approximately opposite the aspherical region 3 has a planar, i.e. flat, form in this embodiment. The lens 1 projects with this area over the underside of the cylinder head 9 and of the sleeve 11, which guarantees a flushing-through by the combustion gases located in the combustion chamber during operation of the internal combustion engine, which reduces the deposits on the window.

The laser radiation 15, produced by a laser source, not represented, and introduced into the cylinder head via means which are not represented (e.g. light guides), is focused by the lens 1 according to the invention alone in the combustion chamber onto a focal point 16.

FIG. 2 differs from FIG. 1 in that in this embodiment the lens 1 has an aspherical region 3 in which, for each point on the surface of the aspherical region 3, the distance to the center M of the lens 1 is greater than the radius R of the lens.

In FIG. 3 a further embodiment of a lens 1 according to the invention is represented. Just as in FIG. 1, in the aspherical region 3 (up to the area near to the axis θ-0°) the distance from each point on the surface is smaller than the radius R of the spherical basic shape 2 of the lens 1.

By contrast to what is shown in the embodiments according to FIGS. 1 to 3, the aspherical region 3 can also be arranged on the side of the lens 1 facing the combustion chamber, e.g. instead of the flattening shown in FIGS. 1-3 (area 5). By this measure a higher numerical aperture can be achieved and thus a lower ignition energy obtained.

1. A lens for a laser-ignited internal combustion engine, comprising:
a lens having an at least approximately spherical basic shape, wherein the lens has an aspherical region formed so that the lens is substantially free from spherical aberration.

2. The lens according to claim 1, wherein the aspherical region is formed rotationally symmetrically in relation to an imaginary axis running through the center of the spherical basic shape.

3. The lens according to claim 2, wherein the aspherical region extends in relation to the imaginary axis from a polar angle θ=0° to at least approximately θ=45°.

4. The lens according to claim 3, wherein the aspherical region extends to approximately θ=90°.

5. The lens according to claim 1, wherein the aspherical region has at least one portion wherein each point on the surface of the at least one portion has a distance from the center of the spherical basic shape that is smaller than the radius of the spherical basic shape.

6. The lens according to claim 1, wherein the aspherical region has at least one portion wherein each point on the surface of the at least one portion has a distance from the center of the spherical basic shape that is greater than the radius of the spherical basic shape.

7. The lens according to claim 5, wherein the portion in which the distance of each point on the surface differs from the radius of the spherical basic shape, is formed rotationally symmetrically in relation to an imaginary axis running through the center of the spherical basic shape.

8. The lens according to claim 1, wherein, in the area of an antipode to the aspherical region, it is formed at least approximately planar, concave or convex.

9. The lens according to claim 1, wherein the aspherical region is formed as a simple continuation of the surface of the lens.

10. The lens according to claim 1, wherein the lens is made of a quartz glass, crystalline quartz, calcium fluoride, borosilicate glass, silica glass or sapphire.

11. A method for the production of a lens according to claim 1, wherein the aspherical region is worked into an approximately spherical unfinished lens.

12. The method according to claim 11, wherein the aspherical region is ground into an approximately spherical unfinished lens.

13. The method for the production of a lens according to claim 11, wherein the raw material is pressed in a mould which is complementary to the intended shape of the lens.

14. A lens according to claim 1 further comprising a housing for the lens, wherein the housing has seating surfaces which are formed for the play-free housing of the lens, and in that it is formed for fitting in a bore in a cylinder head of an internal combustion engine.

15. The lens according to claim 14 wherein the cylinder head bore is of a cylindrical shape.

16. The lens according to claim 14 wherein the housing comprises a hollow cylinder and a sleeve releasably attached the hollow cylinder, the lens being able to be arranged between the hollow cylinder and the fitted sleeve.

17. The lens according claim 16, wherein the sleeve is fitted into the hollow cylinder.

18. The lens according claim 16, wherein the hollow cylinder has at one end seating surfaces, which are formed complementary to a section of the aspherical region of the lens, and the sleeve has seating surfaces which are formed complementary to a section of the spherical basic shape of the lens.

19. The lens according claim 14 further comprising a cylinder head with the housing, and a lens according to claims 1 being arranged in the housing.

20. The lens according claim 19, wherein the lens forms a combustion-chamber window.

21. The lens according claim 20, wherein the lens projects over the underside of the cylinder head.
